(19) United States
(12) Patent Application Publication
(10) Pub. No.: US 2020/0249417 A1
(43) Pub. Date: Aug. 6, 2020

(54) DRIVING APPARATUS AND LENS APPARATUS

(71) Applicant: CANON KABUSHIKI KAISHA, Tokyo (JP)

(72) Inventor: Yasuhiro Hatakeyama, Utsunomiya-shi (JP)

(21) Appl. No.: 16/778,343

(22) Filed: Jan. 31, 2020

(30) Foreign Application Priority Data
Feb. 6, 2019 (JP) 2019-019565

(51) Int. Cl. G02B 7/04

(52) U.S. Cl. CPC G02B 7/04

(57) ABSTRACT

A driving apparatus attachable to and detachable from a lens apparatus, including a zoom lens unit configured to change a focal length and an operation ring configured to be rotated to move the zoom lens unit includes a controller configured to perform control of a velocity at which the operating ring is rotated, based on a designated velocity; and a detector configured to detect a detected member on the operation ring. The detector is configured to detect the detected member having a structure to provide information on which of a first end region, a second end region, and an intermediate region between the first end region and the second end region where the zoom lens unit is located, and output the information. The controller is configured to perform the control based on the output information from the detector.

### BACKGROUND OF THE INVENTION

### Field of the Invention

The present invention relates to a driving apparatus and a lens apparatus.

### Description of the Related Art

There has conventionally been proposed a drive unit (driving apparatus) mounted on a lens and configured to suppress collision noises at a rotation end when a zoom operation ring (also referred to as an operation member) is rotated by the drive unit.

Japanese Patent No. 5782568 discloses a drive unit that includes a position detection system for an operation ring, recognizes the absolute position of the operation ring, and can stop at a rotation end by adjusting and attaching a middle position of a movable range of the operation ring and a reference position of the position detection system.

Japanese Patent Laid-Open No. 2014-126646 discloses a drive unit that can recognize a movable range and an absolute position of an operation ring and stop at rotation ends by performing a reset operation that once collides the operation ring with both the rotation ends after its attachment.

The drive unit has conventionally been attached to a dedicated lens, so frequent attachment and detachment were not performed. However, the recent interchangeable lenses are used for both still image capturing and motion image capturing. Therefore, a drive unit that is not required for the still image capturing may be quickly attached during the motion image capturing and immediately available.

However, the drive unit disclosed in Japanese Patent No. 5782568 needs the position adjustment during the attachment, and cannot provide a quick attachment. The drive unit disclosed in Japanese Patent Laid-Open No. 2014-126646 needs the reset operation after the attachment, so that the imaging state is not immediately available.

### SUMMARY OF THE INVENTION

An aspect of embodiments provides, for example, a driving apparatus beneficial in attachment to and detachment from a lens apparatus.

A driving apparatus according to one aspect of the present invention attachable to and detachable from a lens apparatus, including a zoom lens unit configured to change a focal length and an operation ring configured to be rotated to move the zoom lens unit includes a controller configured to perform control of a velocity at which the operating ring is rotated, based on a designated velocity; and a detector configured to detect a detected member on the operation ring. The detector is configured to detect the detected member having a structure to provide information on which of a first end region, a second end region, and an intermediate region between the first end region and the second end region where the zoom lens unit is located, and output the information. The controller is configured to perform the control based on the output information from the detector.

A lens apparatus according to another aspect of the present invention includes a zoom lens unit configured to change a focal length, and an operation ring configured to be rotated to move the zoom lens unit, and a driving apparatus is attachable to and detachable from, the driving apparatus causing the operation ring to be rotated based on a designated velocity further includes a detected member provided with the operation ring, to be detected by a detector included in the driving apparatus, and having a structure to provide information on which of a first end region, a second end region, and an intermediate region between the first end region and the second end region where the zoom lens unit is located.

Further features of the present invention will become apparent from the following description of exemplary embodiments with reference to the attached drawings.

### BRIEF DESCRIPTION OF THE DRAWINGS

FIG. 1 is a perspective view of an image pickup apparatus according to one embodiment of the present invention.

FIG. 2A is a perspective view of a lens barrel.

FIG. 2B is a perspective view of a drive unit.

FIG. 3 is a block diagram of the image pickup apparatus.

FIG. 4 illustrates a detected member.

FIGS. 5A and 5B illustrate an operation ring and the drive unit viewed from a camera body side.

FIGS. 6A to 6C explain a method for detecting area information using a detector and a detected member according to a first embodiment.

FIG. 7 is a developed view of a modified example of a detected surface.

FIG. 8 is a flowchart illustrating a main routine of driving processing of the operation ring according to a first embodiment.

FIG. 9 is a flowchart illustrating a rotational velocity determination subroutine of the operation ring according to the first embodiment.

FIGS. 10A to 10C explain a method for detecting area information using a detector and a detected member according to a second embodiment.

FIGS. 11A to 11C explain a method for detecting area information using a detector and a detected member according to a third embodiment.

### DESCRIPTION OF THE EMBODIMENTS

Referring now to the accompanying drawings, a detailed description will be given of embodiments according to the present invention. Corresponding elements in respective figures will be designated by the same reference numerals, and a duplicate description thereof will be omitted.

### First Embodiment

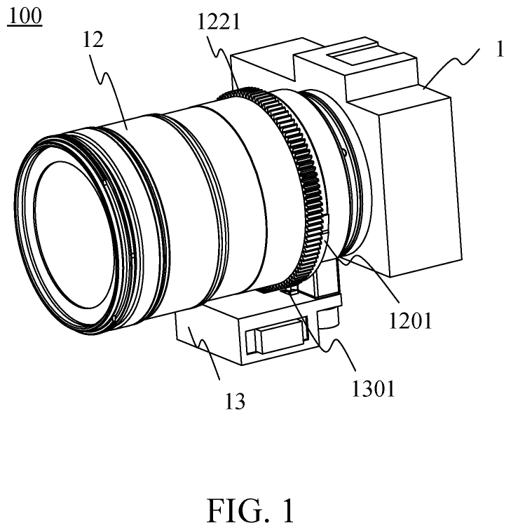

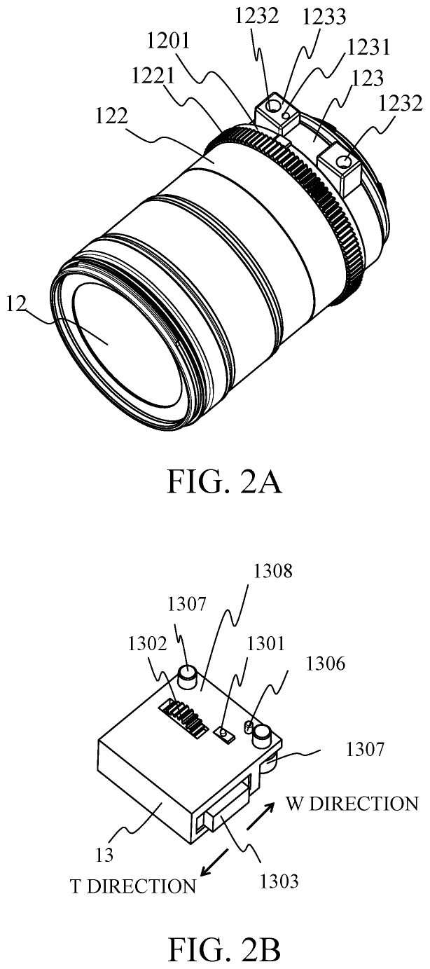

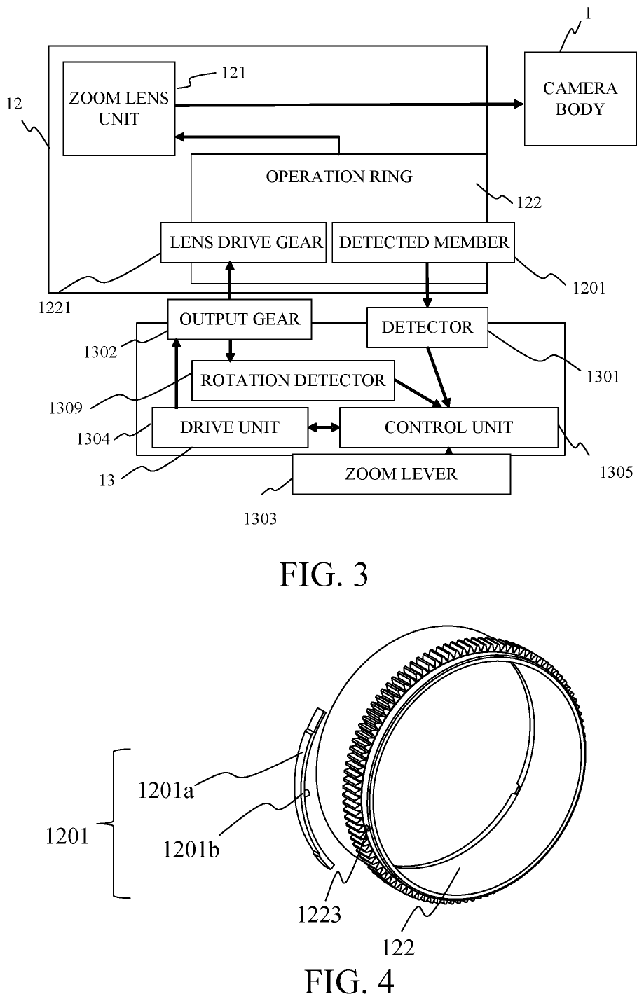

FIG. 1 is a perspective view of an image pickup apparatus 100 according to one embodiment of the present invention. FIG. 2A is a perspective view of a lens barrel (lens apparatus) 12. FIG. 2B is a perspective view of a drive unit (driving apparatus) 13. FIG. 3 is a block diagram of the image pickup apparatus 100.

The image pickup apparatus 100 includes a camera body 1, the lens barrel 12, and the drive unit 13 that is attachable to and detachable from the lens barrel 12.

The lens barrel 12 is a zoom lens. The lens barrel 12 includes a zoom lens unit 121, an operation ring 122, and an exterior ring (also referred to as an exterior barrel or an exterior member) 123. The zoom lens unit 121 can change the focal length of the lens barrel 12. The operation ring 122 moves the zoom lens unit 121 while rotating, and adjusts the zoom magnification. The operation ring 122 is provided with a detected member (detected member) 1201 and a lens drive gear 1221. The exterior ring 123 is fixed onto the camera body 1 in the imaging state. A positioning hole 1231, a screw hole 1232, and a plane portion 1233 are provided on the outer circumference of the exterior ring 123. The positioning hole 1231, the screw hole 1232, and the plane portion 1233 are used when the drive unit 13 is attached to and detached from the lens barrel 12.

The zoom lens unit 121 may include a plurality of lenses or a single lens. The lens barrel 12 may include a plurality of zoom lens units 121. When the lens barrel 12 includes a plurality of zoom lens units 121, a lens distance that changes during zooming is set as a boundary between the zoom lens units.

The drive unit 13 has a detector (detector) 1301, an output gear 1302, a zoom lever 1303, a drive unit 1304, a control unit (controller) 1305, a positioning pin 1306, an attachment screw 1307, an attachment surface 1308, and a rotation detector 1309. The detector 1301 acquires the position information of the zoom lens unit 121 by detecting the detected member 1201. The zoom lever 1303 is a user operation unit that can be operated in W and T directions in FIG. 2B, and detects operation information by the user. The drive unit 1304 generates a rotational force by an actuator and a reduction gear provided therein, and transmits the rotational force to the output gear 1302. The torque transmitted to the output gear 1302 is transmitted to the lens drive gear 1221. Thereby, the operation ring 122 rotates. The control unit 1305 acquires operation information of the zoom lever 1303 and controls driving of the drive unit 1304. The positioning pin 1306, the attachment screw 1307, and the attachment surface 1308 are used when the drive unit 13 is attached to and detached from the lens barrel 12. The rotation detector 1309 detects a driving state of the output gear 1302.

A description will be given of a configuration of the detector 1301 and the detected member 1201, and a method of detecting the position information of the zoom lens unit 121 using these members according to this embodiment.

The detector 1301 includes a detection pin 1301a that is biased to move back and forth relative to the detected member 1201, and a sensor whose electric resistance value changes according to the position of the detection pin 1301a.

FIG. 4 illustrates the detected member 1201. The detected member 1201 includes a detected surface 1201a and an attachment pin 1201b. The detected member 1201 is attached to the operation ring 122 by inserting the attachment pin 1201b into an attachment hole 1223 provided in the operation ring 122. The detected surface 1201a faces the outside of the operation ring 122. In this embodiment, the detected member 1201 is attachable to and detachable from the operation ring 122, but may be integrated with the operation ring 122.

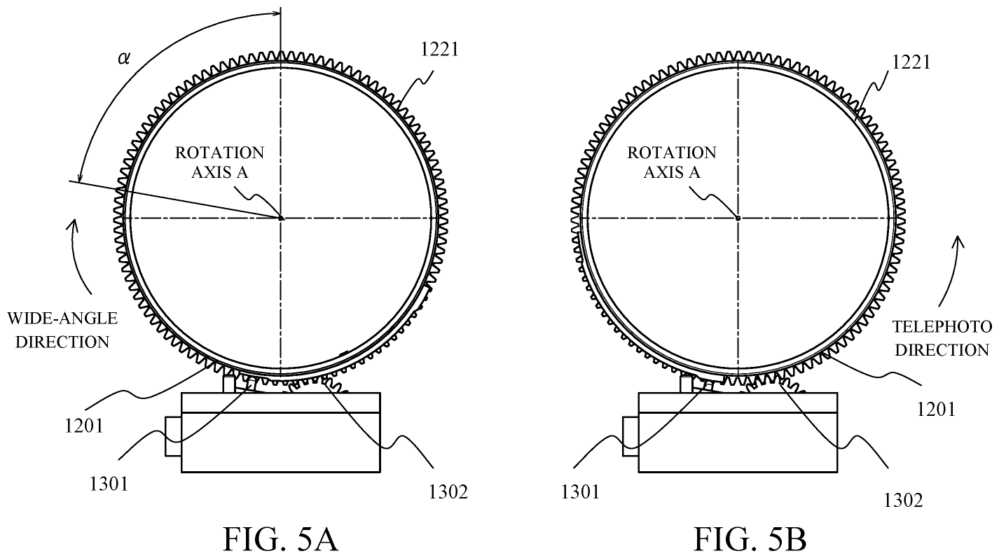

FIGS. 5A and 5B illustrate the operation ring 122 and the drive unit 13 viewed from the camera body 1 side. FIG. 5A illustrates a state where the operation ring 122 reaches a first rotation end and the zoom lens unit 121 reaches the wide-angle end. FIG. 5B illustrates a state where the operation ring 122 reaches a second rotation end and the zoom lens unit 121 reaches the telephoto end. The operation ring 122 rotates around a rotation axis A by a rotation angle a from the first rotation end to the second rotation end. The detected member 1201 is detectable by the detector 1301 while the operation ring 122 rotates by the rotation angle α.

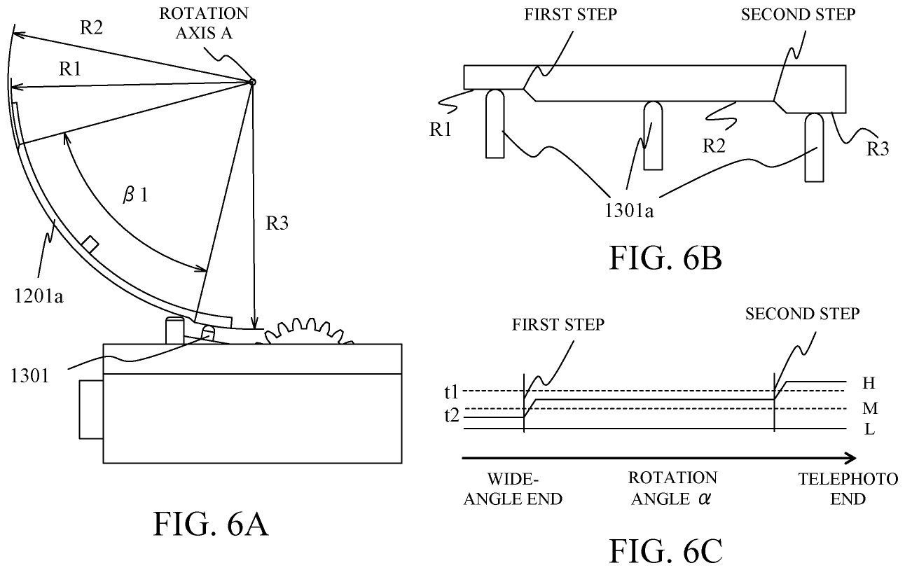

FIGS. 6A and 6B explain the method of detecting the area information of the operation ring 122 using the detector 1301 and the detected member 1201 according to this embodiment. FIG. 6A illustrates the detector 1301 and the detected member 1201 viewed from the camera body 1 side. FIG. 6B illustrates a positional relationship between the detector 1301 and the detected member 1201. FIG. 6C illustrates a detection result of the detector 1301.

The detected surface 1201a includes a first end region, a second end region, and an intermediate area between the first end region and the second end region. In this embodiment, when the detection pin 1301a contacts the first end region, the zoom lens unit 121 is located in the wide-angle end region. When the detection pin 1301a contacts the second end region, the zoom lens unit 121 is located at the telephoto end region. When the detection pin 1301a contacts the intermediate area, the zoom lens unit 121 is located in the zoom area between the wide-angle end region and the telephoto end region. The first end region, the intermediate area, and the second end region are three arc surfaces each having a radius R1, R2, and R3 around the rotation axis A serving as a center. In this embodiment, the radius of each area has a relationship of R1<R2<R3. A boundary between the first end region and the intermediate area will be referred to as a first step, and the boundary between the intermediate area and the second end region will be referred to as a second step. The angle formed by the rotation axis A, the first step, and the second step with the rotation axis A as the vertex will be defined as an angle β1.

As illustrated in FIG. 6B, the detection pin 1301a of the detector 1301 moves forward and backward according to the contact area. As illustrated in FIG. 6C, the detector 1301 uses the detection values corresponding to the advance or retreat position (or moving position) of the detection pin and thresholds t1 and t2 to detect the area information (any of L, M, or H) that is the position information of the operation ring 122. The detected area information is transmitted to the control unit 1305. In this embodiment, when the detector 1301 outputs the area information L, it indicates that the detection pin 1301a contacts the first end region. When the detector 1301 outputs the area information M, it indicates that the detection pin 1301a contacts the intermediate area. When the detector 1301 outputs the area information H, it indicates that the detection pin 1301a contacts the second end region.

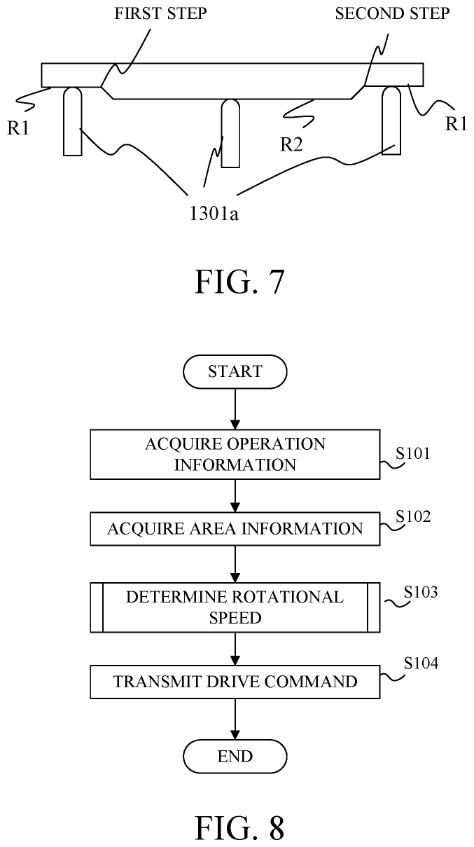

In this embodiment, each area is constituted by an arc surface having a different radius, but at least the intermediate area may be constituted by an arc surface having a different radius from that of each of the first and second end regions. For example, as illustrated in FIG. 7, the first end region and the second end region may be an arc surface having a radius R1, and the intermediate area may be an arc surface having a radius R2. In this embodiment, the radius of each area has a relationship of R1<R2<R3, but the present invention is not limited to this embodiment. For example, the radius of each area may have a relationship of R1>R2>R3, or may have a relationship of R2>R1>R3.

In this embodiment, since the detector 1301 detects the detected member 1201 by the physical contact, the detected member 1201 can be reliably detected without being affected by the disturbance such as external light or magnetism.

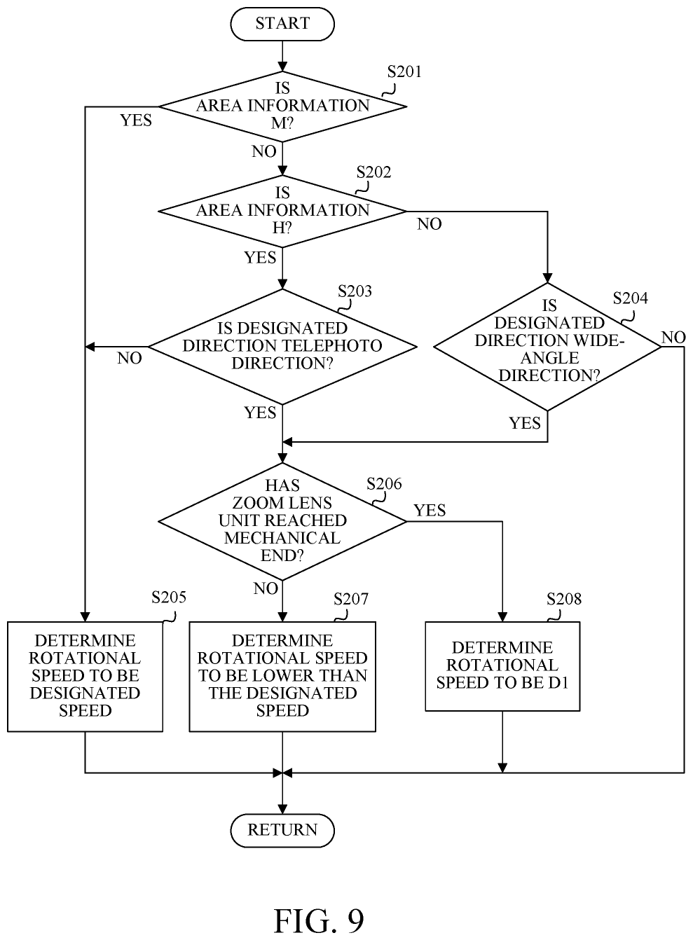

Referring now to FIG. 8 or 9, a description will be given of driving processing of the operation ring 122 for suppressing the collision noises at the rotation end performed by the control unit 1305.

FIG. 8 is a flowchart illustrating a main routine of the driving processing of the operation ring 122.

In the step S101, the control unit 1305 acquires the operation information for the zoom lever 1303. More specifically, the control unit 1305 acquires an instruction velocity according to the operation amount of the zoom lever 1303 and an instruction direction to the operation ring 122 corresponding to the operation direction of the zoom lever 1303. When the operation direction of the zoom lever 1303 is a W direction, the designated direction is the wide-angle direction in FIG. 5A (the rotation direction of the operation ring 122 toward the first rotation end). When the operation direction of the zoom lever 1303 is a T direction, the designated direction is the telephone direction in FIG. 5B (the rotation direction of the operation ring 122 toward the second rotation end).

In the step S102, the control unit 1305 acquires the area information (any of L, M, or H) from the detector 1301.

In the step S103, the control unit 1305 executes a rotational velocity determination subroutine and determines the rotational velocity of the operation ring 122.

FIG. 9 is a flowchart showing the rotational velocity determination subroutine of the operation ring 122.

In the step S201, the control unit 1305 determines whether or not the area information is M. If the area information is M, the flow proceeds to the step S205. If the area information is not M, the flow proceeds to the step S202.

In the step S202, the control unit 1305 determines whether or not the area information is H. If the area information is H, the flow proceeds to step S203. If the area information is not H or if the area information is L, the flow proceeds to step S204.

In the step S203, the control unit 1305 determines whether the designated direction is the telephoto direction. If the designated direction is the telephoto direction or the direction in which the zoom lens unit 121 collides with the telephoto end, the flow proceeds to step S206. If the designated direction is not the telephoto direction or the direction in which the detector 1301 can detect the area information M, the flow proceeds to step S205.

In the step S204, the control unit 1305 determines whether the designated direction is the wide-angle direction. If the designated direction is the wide-angle direction or the direction in which the zoom lens unit 121 collides with the wide-angle end, the flow proceeds to step S206. If the designated direction is not the wide-angle direction or the direction in which the detector 1301 can detect the area information M, the flow proceeds to step S205.

In the step S205, the control unit 1305 determines the rotational velocity of the operation ring 122 to be the designated velocity.

In the step S206, the control unit 1305 determines whether the zoom lens unit 121 has reached the mechanical end. When the zoom lens unit 121 has reached the mechanical end, the flow proceeds to step S208. When the zoom lens unit 121 has not reached the mechanical end, the flow proceeds to step S207.

In the step S207, the control unit 1305 determines the rotational velocity of the operation ring 122 to be lower than the designated velocity. The velocity lower than the designated velocity may be zero.

In the step S208, the control unit 1305 determines the rotational velocity of the operation ring 122 to be zero.

According to the flow described above, the control unit 1305 determines the rotational velocity of the operation ring 122.

In the step S104, the control unit 1305 transmits a drive command (the designated direction acquired in the step S101 and the rotational velocity determined in the step S103) to the drive unit 1304, and rotates the operation ring 122 via the drive unit 1304.

As described above, the configuration according to this embodiment requires no adjustment by the user when the drive unit 13 is attached to the lens barrel 12 or no reset operation after the attachment. Further, by using the detected member 1201 and the detector 1301, the current zoom area of the zoom lens unit 121 is detected, and the operating ring 122 is rotated at a rotational velocity according to the situation. Thereby, the collision noises are reduced at the rotation end.

This embodiment divides the detected member into three areas, but the present invention is not limited to this embodiment. For example, each end region may be divided into two areas (a stop region and a deceleration region) to form five areas. In this case, when an operation instruction is given in a direction in which the zoom lens unit 121 collides with the mechanical end in a state where the deceleration region is detected, the operation ring 122 is rotated at a velocity lower than the designated velocity. When an operation instruction is given in the direction in which the zoom lens unit 121 collides with the mechanical end in a state where the stop region is detected, the rotational velocity of the operation ring 122 is set to 0 or the operation ring 122 is stopped.

### Second Embodiment

In this embodiment, the configurations of the detected member and the detector are different from those of the first embodiment. The other configuration is the same as that of the first embodiment, and a detailed description thereof will be omitted.

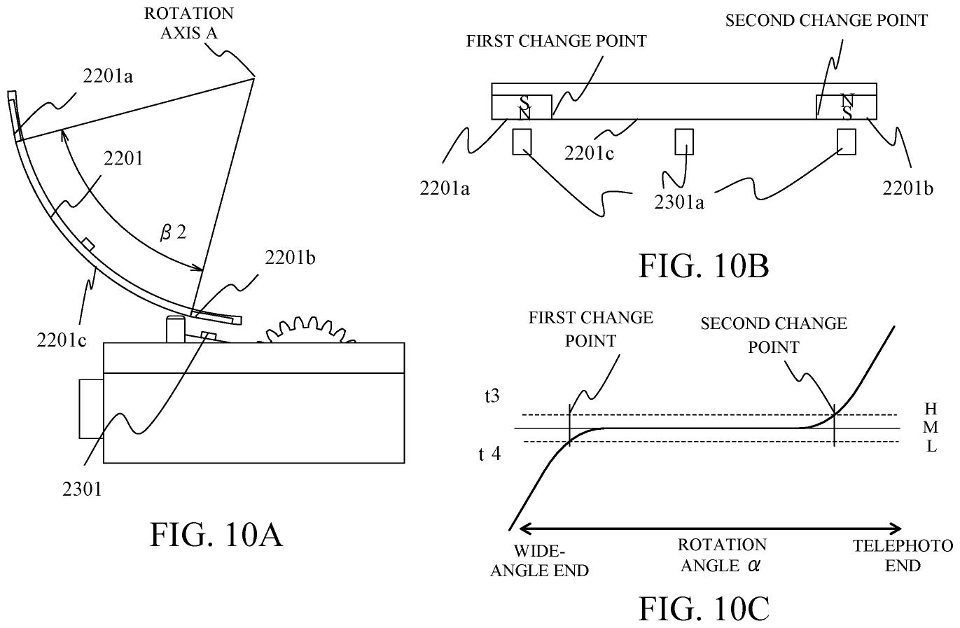

FIGS. 10A to 10C explain a method of detecting area information using a detector 2301 and the detected member 2201 according to this embodiment. FIG. 10A illustrates the detector 2301 and the detected member 2201 viewed from the camera body 1 side. FIG. 10B illustrates a positional relationship between the detector 2301 and the detected member 2201. FIG. 10C illustrates a detection result of the detector 2301.

The detector 2301 includes a sensor 2301a such as a Hall sensor that can convert the magnetic flux on the surface of the detected member 2201 into the voltage.

The detected member 2201 includes magnets 2201a and 2201b and a circular arc portion 2201c made of a nonmagnetic material on a surface facing the detector 2301. The magnets 2201a and 2201b are arranged on both ends of the arc portion 2201c so that the magnetic field directions (polarities appearing on the outer circumference) are different toward the outer circumference of the arc portion 2201c. A boundary between the magnet 2201a and the arc portion 2201c will be referred to as a first change point, and a boundary between the arc portion 2201c and the magnet 2201b will be referred to as a second change point. The angle formed by the rotation axis A, the first change point, and the second change point with the rotation axis A serving as the vertex will be referred to as an angle β2.

In this embodiment, the areas formed by the magnets 2201a and 2201b and the arc portion 2201c on the outer circumference surface of the detected member 2201 correspond to the first end region, the second end region, and the intermediate area, respectively. As illustrated in FIG. 10C, the detector 2301 uses the magnetic flux density according to the positional relationship between the magnets 2201a and 2201b and the circular arc portion 2201c and thresholds t3 and t4 to extract the area information that is the position information of the operation ring 122. The detected area information is transmitted to the control unit 1305.

The configuration according to this embodiment can obtain the effect described in the first embodiment, detect the area information using the noncontact detection method, and have no problems of sliding noises or abrasions, which would otherwise be generated in the contact detection method. Since one sensor is used without being moved as the detector, the area information can be detected with a space-saving and simple configuration.

### Third Embodiment

In this embodiment, the configurations of the detected member and the detector are different from those of the first embodiment. The other configuration is the same as that of the first embodiment, and a detailed description thereof will be omitted.

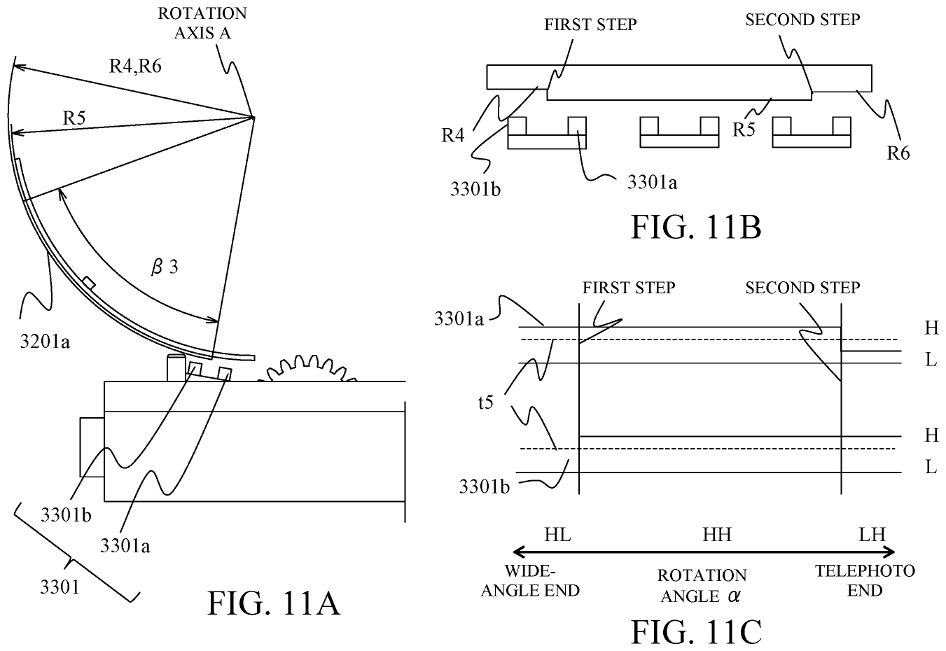

FIGS. 11A and 11B explain a method for detecting area information using a detector 3301 and a detected member 3201 according to this embodiment. FIG. 11A illustrates the detector 3301 and the detected member 3201 viewed from the camera body 1 side. FIG. 11B illustrates the positional relationship between the detector 3301 and the detected member 3201. FIG. 11C illustrates a detection result of the detector 3301.

The detector 3301 includes a first sensor (first detection device) 3301a and a second sensor (second detection device) 3301b. Each sensor detects light reflected from the surface of the detected member 3201, such as a photo-reflector.

The detected surface 1201a includes the first end region, the second end region, and the intermediate area between the first end region and the second end region. The first end region, the intermediate area, and the second end region are three arc surfaces having radii R4, R5, and R6 around the rotation axis A serving as a center. In this embodiment, the radius of each area has a relationship of R4=R6<R5. The boundary between the first end region and the intermediate area will be referred to as a first step, and the boundary between the intermediate area and the second end region will be referred to as a second step. The angle formed by the rotation axis A, the first step, and the second step with the rotation axis A serving as the vertex will be referred to as an angle β3.

As illustrated in FIG. 11C, the first sensor 3301a and the second sensor 3301b detect different values depending on which area of the reflected light is detected. The detector 3301 detects the area information, which is position information of the operation ring 122, using a combination of signals acquired from the respective sensors. In this embodiment, when the first sensor 3301a and the second sensor 3301b have values H and L, the detector 3301 detects the area information L. When the first sensor 3301a and the second sensor 3301b have values H and H, the detector 3301 detects the area information M. When the first sensor 3301a and the second sensor 3301b have values L and H, the detector 3301 detects the area information H.

Since the configuration according to this embodiment can obtain the effect described in the first embodiment, detect the area information using the noncontact detection method, and thus have no problems of sliding noises or abrasions, which would otherwise be generated by the contact detection method. Since the area information is detected using the shape of the detected member, the stable detection can be performed without receiving the influence of the magnetism.

The above embodiments can provide a driving apparatus and a lens apparatus, each of which can suppress collision noises at a rotation end without adjustments during and after the attachment.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-019565, filed on Feb. 6, 2019 which is hereby incorporated by reference herein in its entirety.

What is claimed is:

1. A driving apparatus attachable to and detachable from a lens apparatus, including a zoom lens unit configured to change a focal length and an operation ring configured to be rotated to move the zoom lens unit, the driving apparatus comprising:
a controller configured to perform control of a velocity at which the operating ring is rotated, based on a designated velocity; and
a detector configured to detect a detected member on the operation ring,
wherein the detector is configured to detect the detected member having a structure to provide information on which of a first end region, a second end region, and an intermediate region between the first end region and the second end region where the zoom lens unit is located, and output the information, and
wherein the controller is configured to perform the control based on the output information from the detector.

2. The driving apparatus according to claim 1, wherein the controller is configured to perform the control at the designated velocity, based on the output information indicating the intermediate region, and
wherein the controller is configured to perform the control at a velocity whose magnitude is lower than that of the designated velocity, based on the output information indicating the first end region or the second end region.

3. The driving apparatus according to claim 1, wherein the controller is configured to perform the control at the designated velocity in a case where the output indicates the first end region and the designated velocity has a first direction toward the intermediate region, and the controller is configured to perform the control at a velocity whose magnitude is lower than that of the designated velocity in a case where the output indicates the first end region and the designated velocity has a second direction opposite to the first direction, and
wherein the controller is configured to perform the control at the designated velocity in a case where the output indicates the second end region and the designated velocity has a third direction, toward the intermediate region and the controller is configured to perform the control at a velocity whose magnitude is lower than that of the designated velocity in a case where the output indicates the second end region and the designated velocity has a fourth direction opposite to the third direction.

4. The driving apparatus according to claim 2, wherein the magnitude lower than that of the designated velocity is zero.

5. The driving apparatus according to claim 1, wherein the first end region includes a first stop region, and a first deceleration region closer to the intermediate region than the first stop region,
wherein the second end region includes a second stop region, and a second deceleration region closer to the intermediate region than the second stop region,
wherein the controller is configured to perform the control at the designated velocity in a case where the output indicates the first deceleration region and the designated velocity has a first direction toward the intermediate region, and the controller is configured to perform the control at a velocity whose magnitude is lower than that of the designated velocity in a case where the output indicates the first deceleration region and the designated velocity has a second direction opposite to the first direction,
wherein the controller is configured to perform the control at the designated velocity in a case where the output indicates the first stop region and the designated velocity has the first direction, and the controller is configured to perform the control to stop the operation ring in a case where the output indicates the first stop region and the designated velocity has the second direction,
wherein the controller is configured to perform the control at the designated velocity in a case where the output indicates the second deceleration region and the designated velocity has a third direction toward the intermediate region, and the controller is configured to perform the control at a velocity whose magnitude is lower than that of the designated velocity in a case where the output indicates the second deceleration region and the designated velocity has a fourth direction opposite to the third direction, and
wherein the controller is configured to perform the control at the designated velocity in a case where the output indicates the second stop region and the designated velocity has the third direction, and the controller is configured to perform the control to stop the operation ring in a case where the output indicates the second stop region and the designated velocity has the fourth direction.

6. The driving apparatus according to claim 1, wherein the detector includes a first detection device and a second detection device, and
wherein a combination of detection results of the first detection device and the second detection device in a case where the output indicates the first end region is different from a combination of detection results of the first detection device and the second detection device in a case where the output indicates the second end region.

7. The driving apparatus according to claim 6, wherein each of the first detection device and the second detection device includes a photo-reflector.

8. A lens apparatus which includes a zoom lens unit configured to change a focal length, and an operation ring configured to be rotated to move the zoom lens unit, and a driving apparatus is attachable to and detachable from, the driving apparatus causing the operation ring to be rotated based on a designated velocity, the lens apparatus further comprising:
a detected member provided with the operation ring, to be detected by a detector included in the driving apparatus, and having a structure to provide information on which of a first end region, a second end region, and an intermediate region between the first end region and the second end region where the zoom lens unit is located.

9. The lens apparatus according to claim 8, wherein the first end region, the second end region, and the intermediate region respectively include arcs having a common center and radii different from one another.

10. The lens apparatus according to claim 8, wherein the first end region and the second end region respectively include arcs having a common center and a same radius, and the intermediate region includes an arc having the common center and a radius different from the same radius.

11. The lens apparatus according to claim 8, wherein the first end region and the second end region respectively include magnets having polarities different from each other.
